(19) United States
(12) Patent Application Publication
(10) Pub. No.: US 2009/0240957 A1
(43) Pub. Date: Sep. 24, 2009

(54) COPY PROTECTION METHOD, CONTENT PLAYBACK APPARATUS, AND IC CHIP

(75) Inventor: Shoichi SANO, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/406,141

(22) Filed: Mar. 18, 2009

(30) Foreign Application Priority Data
Mar. 18, 2008 (JP) 2008-069508

(51) Int. Cl. G06F 11/30

(52) U.S. Cl. 713/193; 726/26

(57) ABSTRACT

An IC chip that can be added to a content recording medium and that has a chip ID which is non-rewritably and uniquely set and originally recorded therein, wherein the IC chip includes a writable/readable ID memory that stores an encrypted content ID obtained by encrypting a content ID that identifies content, and an encrypted chip ID obtained by encrypting the chip ID.

### CROSS-REFERENCE TO RELATED APPLICATION

This application is based upon and claims the benefit of priority from the prior Japanese Patent Application No. 2008-69508 filed on Mar. 18, 2008, the entire contents of which are incorporated herein by reference.

### FIELD

A copy protection method, etc., disclosed herein relates to a copy protection method for preventing a content recording medium from being illicitly copied, and further relates to a content playback apparatus that is compatible with the copy protection method, and an IC chip used in implementation of the copy protection method.

Many types of content recording media for recording various types of content, such as movies, music, and software, are offered on the market. Representative examples of the content recording media include DVDs, CDs, and memory cards.

For so-called copy protection techniques for preventing the content recording media from being illicitly used or illicitly copied, various techniques have been proposed so far and have also been widely put to practical use. Examples of the techniques include the following [Patent Document 1] and [Patent Document 2].

According to an invention of [Patent Document 1], upon executing an application on a personal computer, the application reads an ID recorded in a non-rewritable area of a USB memory external to the personal computer, and when the ID is correct the application is executed.

According to an invention of [Patent Document 2], upon a recording operation, (1) in a distribution apparatus, an ID and a public key Kp are read from a medium and the ID and a common key Kw are encrypted by the public key Kp, and then the encrypted ID and common key Kw are recorded in the medium; and (2) content to be distributed is encrypted by the common key Kw and the encrypted content is stored in the medium. Upon a playback operation, (1) a terminal apparatus (playback apparatus) reads an ID that is not encrypted, an encrypted ID, and an encrypted common key Kw from a medium; (2) the terminal apparatus decrypts the encrypted ID and common key Kw by a secret key Ks held by the terminal apparatus; (3) the terminal apparatus compares the decrypted ID with the unencrypted ID read from the medium to verify that the IDs match each other; and (4) encrypted content is decrypted by the common key Kw obtained by decryption.
[Patent Document 1] Japanese Laid-open Patent Publication No. 2003-288128
[Patent Document 2] Japanese Laid-open Patent Publication No. H11-250571

In conventional typical copy protection methods, a “secret key” is contained in playback apparatuses that are distributed in large numbers on the market. Hence, when the secret key is stolen from a playback apparatus, a common key contained in a content recording medium can be broken. In addition, since a public key is contained in the medium, a pirated edition of content can be easily produced. That is, such methods have a weak copy protection function.

An object of the present invention is therefore to provide a copy protection method with a further enhanced protection function compared to conventional methods.

Furthermore, another object of the present invention is to provide a content playback apparatus and an IC chip that are compatible with the copy protection method.

According to a copy protection method disclosed herein, illicit copying of a content recording medium is prevented by an IC chip which is a hardware chip. Since the IC chip has a unique chip ID originally recorded therein, the chip ID may be used for copy protection. Moreover, an encrypted chip ID obtained by encrypting the chip ID by a secret key known only to a specific manufacturer may be used. In addition, the IC chip stores a content ID that uniquely represents content recorded on a content recording medium to which the IC chip is added. The content ID is also encrypted by the secret key.

Playback of the content is allowed only when IDs respectively obtained by decrypting the encrypted chip ID and the encrypted content ID on a content playback apparatus and the original chip ID can be correctly reproduced in their original forms on the content playback apparatus.

Therefore, even if content (regardless of whether the content is encrypted or not) is copied by malicious third parties, the illicitly copied content cannot be eventually played back unless the content is correctly reproduced as described above. Accordingly, even if malicious third parties succeed in copying the content itself, the content cannot, after all, be played back, thus reducing the possibility of illicit copying. It is sufficient for an IC chip used herein to include at least a memory. Since a high-functionality portion of a CPU is not required, the IC chip is low in cost and small in size.

### SUMMARY

An IC chip that can be added to a content recording medium and that has a chip ID which is non-rewritably and uniquely set and originally recorded therein, wherein the IC chip includes a writable/readable ID memory that stores an encrypted content ID obtained by encrypting a content ID that identifies content, and an encrypted chip ID obtained by encrypting the chip ID.

### BRIEF DESCRIPTION OF THE DRAWINGS

FIG. 1 is a diagram illustrating a first method disclosed in the present specification.

FIG. 2 is a diagram illustrating a second method disclosed in the present specification.

FIG. 3 is a diagram illustrating a specific example of a content playback apparatus 200.

FIG. 4 is a flowchart illustrating a method performed by a manufacturing side 100.

FIG. 5 is a flowchart illustrating a method performed by the side of the content playback apparatus 200.

### DETAILED DESCRIPTION OF THE EMBODIMENTS

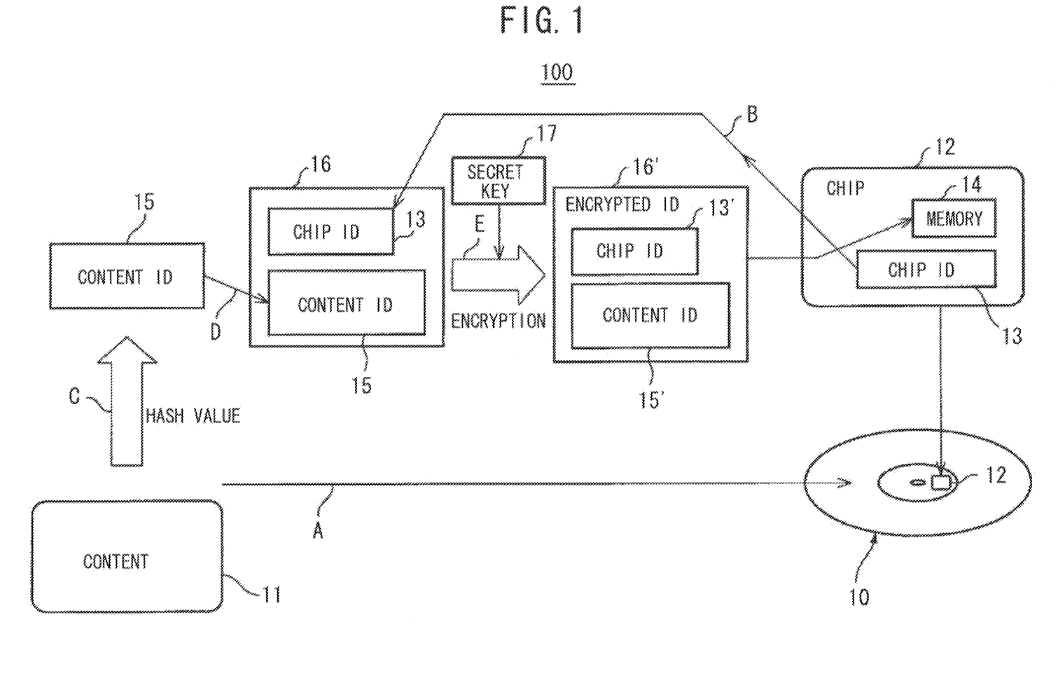

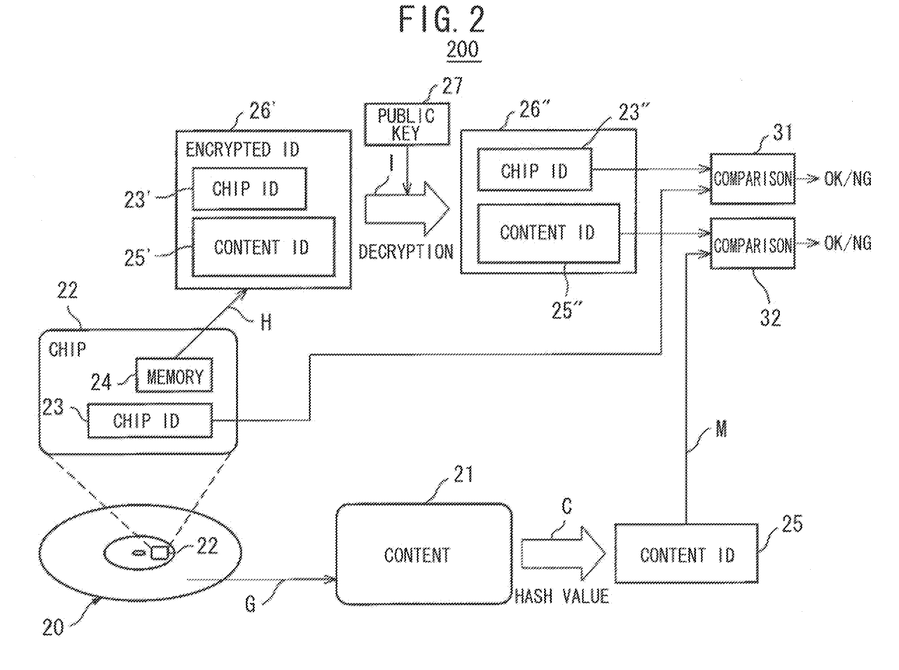

FIG. 1 is a diagram illustrating a first method disclosed in the present specification and FIG. 2 is a diagram illustrating a second method disclosed in the present specification. Note that, as described above, the first method is for when a content recording medium is manufactured and the second method is for when content is played back.

First, referring to a manufacturing side 100 in FIG. 1, a content recording medium 10 represents a content recording medium (hereinafter, also simply referred to as a recording medium) which is a target of copy protection. Content 11 shown at the far left of the drawing is burned (arrow A) onto the content recording medium 10. The content 11 may be, for example, a movie, music, or software. Note that the content 11 may be encrypted or not encrypted and in either case a copy protection function in a copy protection method disclosed herein is not affected.

The portion to which attention should be directed is a block 12 shown at the far right of the drawing. The block 12 is the aforementioned IC chip. a unique chip ID (individual identification number) 13 is originally recorded in the IC chip 12. Also, an ID memory 14 is provided in the IC chip 12.

The first step of the copy protection method disclosed herein is to gather information on a chip ID and a content ID, which is illustrated as ID information 16. A chip ID in the ID information 16 is, as illustrated by arrow B in FIG. 1, the chip ID 13 read out from the IC chip 12. A content ID in the ID information 16 is prepared as follows.

First, a specific computation process is performed on the content 11 (see arrow C in FIG. 1) to obtain a content ID 15. An example of the specific computation process includes a hash function computation. By this computation, a “hash value” may be obtained. By using the hash function, for example, a hash value (content ID) of 128 bytes that uniquely identifies the content 11 of 5 gigabytes, for example, can be obtained. The content ID 15 thus obtained is entered as one piece of the ID information 16.

In the second step, the ID information 16 is encrypted (see arrow E). The encryption is performed using a secret key 17, whereby encrypted ID information 16′ is obtained. In this case, the secret key 17 is only known to a limited number of people such as a specific manufacturer (e.g., an IC chip manufacturer) and thus has a high level of confidentiality.

In this way, the encrypted ID information 16′ including an encrypted chip ID 13′ and an encrypted content ID 15′ is obtained. The ID information 16′ is then stored in the ID memory 14 in the IC chip 12.

The IC chip 12 thus processed is added to a corresponding unique content recording medium 10 and the content recording medium 10 is distributed on the market for purchase by users.

A content recording medium 10 with an IC chip which is bought by a user on the market is set, for example, on a content playback apparatus (player) in a user's home. If the recording medium with an IC chip is one that is illicitly manufactured (e.g., a pirated edition), then playback cannot be performed. The prevention of the playback in this case is enabled by the second method.

Now, the second method will be explained with reference to FIG. 2. In FIG. 2, the above-described content playback apparatus (hereinafter, also simply referred to as a “playback apparatus”) is represented by reference numeral 200. In the first step, content 21 is read out (arrow G) from a content recording medium 20 set on the playback apparatus 200. Also, an encrypted chip ID 23′ and an encrypted content ID 25′, which are stored in an ID memory 24 in the IC chip 22, and a chip ID 23 are read out (arrow H) from an IC chip 22 added to the content recording medium 20 to regenerate encrypted ID information 26′.

Then, in the second step, the computation process as the aforementioned specific computation process (arrow C in FIG. 1) is performed on the content 21 read out (arrow G) to generate a content ID 25 (arrow C in FIG. 2).

Furthermore, in the third step, the encrypted chip ID 23′ and the encrypted content ID 25′ that form the encrypted ID information 26′ are decrypted by a public key 27 (arrow I in FIG. 2). In this way, decrypted ID information 26″ is obtained and a decrypted chip ID 23″ and a decrypted content ID 25″, e.g., an original chip ID and an original content ID, are reproduced.

In the fourth step, a match/mismatch between the respective IDs reproduced in the above-described manner is detected by a first comparing unit 31 and a second comparing unit 32. The first comparing unit 31 compares the reproduced chip ID 23″ with the chip ID 23 read out from the IC chip 22, to determine whether the IDs match (OK) or mismatch (NG).

In parallel with this, the second comparing unit 32 compares the reproduced content ID 25″ with the content ID 25 computed by the hash function, to determine whether the IDs match (OK) or mismatch (NG).

Thus, whether the content recording medium 20 is one that is illicitly copied or not may be detected. When results of the comparisons (31 and 32) both match (OK), the content recording medium 20 is an authentic product (e.g., the content recording medium 10) and thus the playback apparatus 200 can play back the content. In contrast, when at least one of the results of the comparisons (31 and 32) does not match (NG), the content recording medium 20 may be an illicitly copied product and thus the playback apparatus 200 cannot play back the content. Even if malicious third parties produce illicitly copied products, the products cannot, after all, be played back and thus are useless as products for sale. Accordingly, the third parties may not plan making such illicit copies from the beginning.

Examples of preventing such illicit copying include the following (a) and (b). Specifically,

(a) the content recording medium 10 having the IC chip 12 added thereto, shown at the far right of FIG. 1, is offered on the market. Suppose that a third party removes the IC chip 12 from the medium 10 and illicitly adds an IC chip of another recording medium.

Suppose that such a recoding medium is set on the playback apparatus 200. If the IC chip 12 is used as is, two chip IDs match each other and thus a matching determination performed by the first comparing unit 31 is cleared. However, if two pieces of content are different, their hash values (content IDs) do not match each other and thus a matching determination performed by the second comparing unit 32 cannot be cleared (NG). As a result, content on the recording medium cannot be played back.

(b) Suppose that a third party produces an illicitly copied product in which a similar IC chip is added to a recording medium (e.g., a pirated edition) having illicitly copied content of the content recording medium 10. Since a chip ID of the similar IC chip and a chip ID reproduced from an ID memory 24 do not match each other (chip IDs are all unique), a comparison result obtained by the first comparing unit 31 indicates “NG” and thus the content cannot be played back. Even if the third party manages to learn the chip ID of the IC chip 12, the third party cannot learn the secret key 17 and thus can neither generate the original encrypted chip ID 13′ nor generate the same content ID as that of the authentic product.

The above-described IC chip 12 will be summarized. The IC chip can be added to a content recording medium 10 and has a chip ID 13 which is non-rewritably and uniquely set and originally recorded therein. The IC chip includes a writable/readable ID memory 14 that stores an encrypted content ID 15′ obtained by encrypting a content ID 15 that identifies the content 11, and an encrypted chip ID 13′ obtained by encrypting the chip ID 13.

The content ID 15 is generated from a computed value of n (n<<N) bytes obtained by performing a computation operation on N-byte digital data forming the content 11, using a specific function. The specific function may be, for example, a hash function, and the computed value may be a hash value obtained using the hash function.

The content ID 15 and the chip ID 13 are encrypted by a first key (17), and the encrypted content ID 15′ and the encrypted chip ID 13′ are generated. The first key makes a pair with a second key (27) used to decrypt the encrypted content ID 15′ and the encrypted chip ID 13′ when the content 11 recorded on the content recording medium 10 is played back. In this case, the first key (17) is a secret key 17 that is secretly held only by a manufacturer of the IC chip 12, and the second key (27) is a public key 27 publicly provided to each content playback apparatus 200 that plays back the content 11 recorded on the content recording medium 10.

It is desirable that the IC chip 12 be manufactured by a manufacturer different from a manufacturer of the content recording medium 10 to further enhance the secrecy of the IC chip 12. A content recording medium 10 having such an IC chip 12 added is new. The IC chip 12 may be added to the content recording medium 10 by, for example, bonding or embedding.

Next, a specific example of the content playback apparatus 200, the concept of which is illustrated in FIG. 2, will be described.

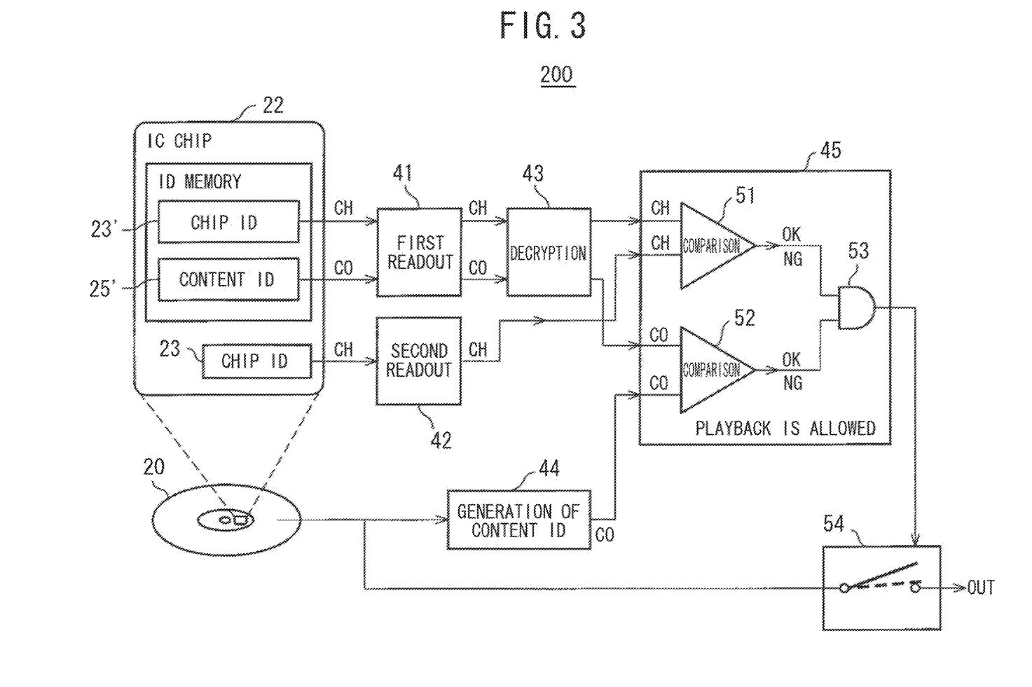

FIG. 3 is a diagram illustrating a specific example of the content playback apparatus 200. In the drawing, the content playback apparatus 200 has a first readout function unit 41 and a second readout function unit 42.

The first readout function unit 41 reads out an encrypted content ID 25′ and an encrypted chip ID 23′ from an IC chip 22 added to a content recording medium 20. The content recording medium 20 has an ID memory 24 that stores an encrypted content ID 15′ and an encrypted chip ID 13′ which are respectively obtained by encrypting, by a first key (17), a content ID 15 and a chip ID 13. The content ID 15 is obtained by a specific process based on content 11 to uniquely identify the content 11. The chip ID 13 is uniquely set and non-rewritably and originally recorded in an IC chip 12.

The second readout function unit 42 reads out a chip ID 23 contained in the IC chip 22 itself. Although, as stated above, the content ID 15 and the chip ID 13 each are encrypted by the first key, e.g., the IDs are separately encrypted, encryption is not limited thereto and the content ID 15 and the chip ID 13 may be combined into one ID data unit and the ID data unit may be encrypted once.

The content playback apparatus 200 further has a decryption unit 43. The decryption unit 43 decrypts the read encrypted content ID 25′ and encrypted chip ID 23′ with a second key (27) which makes a pair with the first key (17) and regenerates an original content ID 25″ and an original chip ID 23″.

The content playback apparatus 200 also has a content ID generation unit 44 that generates a content ID 25 obtained by performing the same process as the aforementioned specific process on content 21 recorded on the content recording medium 20.

The content playback apparatus 200 has a playback allowance function unit 45 that allows playback of the content 21 only when decrypted data units (CH and CO) from the decryption unit 43 match output data units (CH and CO) from the second readout function unit 42 and the content ID generation unit 44 respectively. The playback allowance unit 45 includes a chip ID comparing unit 51 that detects a match/mismatch between the decrypted chip ID (CH) from the decryption unit 43 and the chip ID (CH) from the second readout unit 42; and a content ID comparing unit 52 that detects a match/mismatch between the decrypted content ID (CO) from the decryption unit 43 and the content ID (CO) from the content ID generation unit 44.

When both comparison results from the two comparing units 51 and 52 match (OK), a second gate (corresponding to a switch) 54 is turned on through a first gate (corresponding to an AND) 53 and the content 21 of the authentic recording medium 20 (e.g., the content 11 of the original recording medium 10) is transferred to, for example, a movie/music playback unit (not shown).

Note that, as described above, the content ID 15 is a computed value of n (n<<N) bytes obtained by performing a computation operation on N-byte digital data forming the content 11, using a specific function, and the specific function may be a hash function and the computed value may be a hash value obtained using the hash function.

The above-described FIGS. 1 and 2 illustrate the first method (for manufacturing) and the second method (for playing back). These methods are represented by specific flowcharts below.

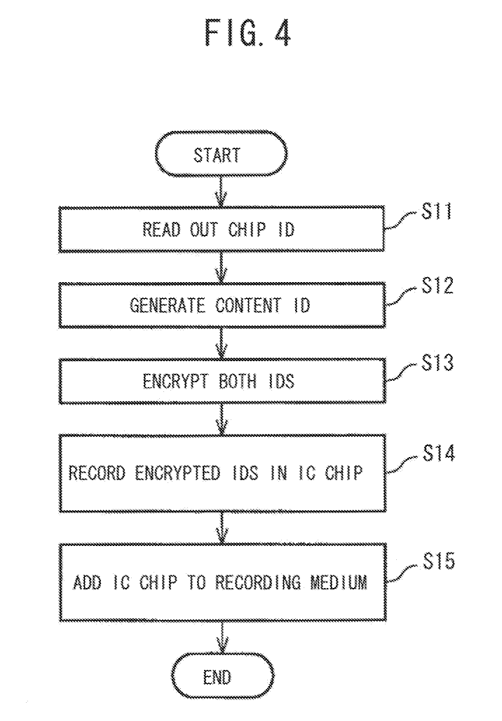

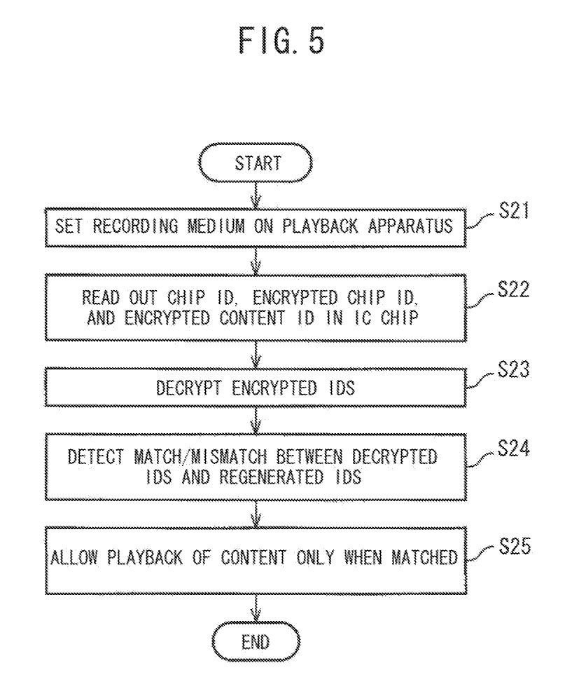

FIG. 4 is a flowchart illustrating a method performed by the manufacturing side 100 and FIG. 5 is a flowchart illustrating a method performed by the side of the playback apparatus 200. First, FIG. 4 will be referred to.

In the drawing, at operation S11, a chip ID 13 that is originally recorded in an IC chip 12 and uniquely identifies the IC chip 12 is read out.

At operation S12, a content ID 15 that uniquely identifies content 11 recorded on a content recording medium 10 is generated.

At operation S13, the chip ID 13 and the content ID 15 are encrypted.

At operation S14, an encrypted chip ID 13′ and an encrypted content ID 15′ are recorded in the IC chip 12.

At operation S15, the IC chip 12 storing the encrypted chip ID 13′ and the encrypted content ID 15′ is added to the content recording medium 10.

The manufactured content recording medium 10 with an IC chip is supplied on the market.

Next, referring to FIG. 5, at operation S21, a content recording medium 20 having an IC chip 22 is set on a content playback apparatus 200. The IC chip 22 stores an encrypted chip ID 13′ and an encrypted content ID 15′. The encrypted chip ID 13′ is obtained by encrypting, by a first key (17), a chip ID 13 which is uniquely set and non-rewritably and originally recorded in the IC chip.

The encrypted content ID 15′ is obtained by encrypting, by the first key (17), a content ID 15 generated by a specific process to uniquely identify a content 11 recorded on a content recording medium 10.

At operation S22, a chip ID 23, an encrypted chip ID 23′, and an encrypted content ID 25′ in the IC chip 22 are read out.

At operation S23, the read encrypted chip ID 23′ and encrypted content ID 25′ are decrypted by a second key (27) which makes a pair with the first key (17).

At operation S24, a match/mismatch between a chip ID 23″ and a content ID 25″ which have been decrypted and regenerated and the read chip ID 23 and a content ID 25 generated by the same process as the aforementioned specific process is detected.

At operation S25, only when results of the detections each match, playback of content 21 on the content playback apparatus 200 is allowed. The content 21 is exactly the same as the content 11 contained in the authentic recording medium 10.

Points of the above-described copy protection methods are summarized as illustrated in the following (1) to (4).
(1) A content ID corresponding to content is contained in a content recording medium by means of hardware (chip) to make duplication difficult.
(2) A content ID that is dependent on content is used to prevent an IC chip from being used (diverted) for other content.
(3) Under an environment in which only an allowed manufacturer (a manufacturer having a secret key) can manufacture a medium, a content ID and a chip ID are encrypted and the encrypted content ID and chip ID are written in an IC chip.
(4) To improve the security management of a manufactured content recording medium, an IC chip containing content information and a recording medium containing content itself can be separately manufactured.

Effects of the points are listed below in (a) to (d).
(a) By using a copy protection method disclosed herein when software is put into a recording medium and the recording medium is sold, illicit duplication of the medium can be prevented and the authenticity of the software may be proved. Specifically, even if an authentic IC chip is removed from an authentic medium and the IC chip is added to another medium and then tampered software is put into the medium, by referring to a content ID in the IC chip, it can be easily found that the software is tampered or otherwise altered.
(b) A certain manufacturer manufactures IC chips in which content IDs are respectively written and distributes the IC chips to a plurality of medium manufacturers, whereby convenience in content management, such as the number of pieces of content manufactured and by which medium manufacturer a certain recording medium is manufactured, is improved. Specifically, by separating an IC chip manufacturer and a recording medium manufacturer, more strict content management is performed. If writing of content IDs in IC chips and manufacturing of recording media are left to a single manufacturer, it becomes difficult to externally grasp the number of burned chips manufactured, facilitating illicit activity.
(c) A chip ID which is a hardware chip cannot be copied. Also, an encrypted content ID cannot be tampered or otherwise altered. Therefore, even when only content is copied onto another recording medium, the content cannot be played back, helping to prevent illegal copying.
(d) Regardless of whether content is encrypted or not, even when only the content is copied onto another medium and the medium is distributed, unless a modified player that is configured not to check a chip ID is provided together with the medium, a user who receives the pirated medium cannot play back the illicit content. To produce a perfect pirated medium, a secret key known only to a manufacturer needs to be stolen and an IC chip in which nothing is written needs to be obtained. However, doing so is extremely difficult.

1. There is provided an IC chip that can be added to a content recording medium and that has a chip ID which is non-rewritably and uniquely set and originally recorded therein, wherein
the IC chip includes a writable/readable ID memory that stores an encrypted content ID obtained by encrypting a content ID that identifies a content; and an encrypted chip ID obtained by encrypting the chip ID.

2. The IC chip according to claim 1, wherein the content ID is a computed value of n (n<<N) bytes obtained by performing a computation operation on N-byte digital data forming the content, using a specific function.

3. The IC chip according to claim 1, wherein the encrypted content ID and the encrypted chip ID are respectively generated by encrypting the content ID and the chip ID by a first key.

4. The IC chip according to claim 3, wherein the first key makes a pair with a second key used to decrypt the encrypted content ID and the encrypted chip ID when the content recorded on the content recording medium is played back.

5. A content recording medium having added thereto a copy protection IC chip according to claim 1.

6. A content playback apparatus comprising:
a first readout function unit that reads out an encrypted content ID and an encrypted chip ID from an IC chip added to a content recording medium having an ID memory that stores the encrypted content ID and the encrypted chip ID which are obtained by encrypting, by a first key, a content ID and a chip ID, the content ID being obtained by a specific process based on content to uniquely identify the content and the chip ID being uniquely set and non-rewritably and originally recorded in the IC chip; and a second readout function unit that reads out the chip ID contained in the IC chip itself;
a decryption function unit that decrypts the read encrypted content ID and encrypted chip ID by a second key and regenerates the original content ID and chip ID, the second key making a pair with the first key;
a content ID generation function unit that generates a content ID obtained by performing a same process as the specific process on content recorded on the content recording medium; and
a playback allowance function unit that allows playback of the content only when decrypted data from the decryption function unit match output data from the second readout function unit and the content ID generation function unit.

7. A copy protection method comprising:
reading out a chip ID that is originally recorded in an IC chip and uniquely identifies the IC chip;
generating a content ID that uniquely identifies content recorded on a content recording medium;
encrypting the chip ID and the content ID;
recording the encrypted chip ID and the encrypted content ID in the IC chip; and
adding the IC chip storing the encrypted chip ID and the encrypted content ID to the content recording medium.

8. A copy protection method comprising:
when setting a content recording medium on a content playback apparatus, the content recording medium having an IC chip that stores an encrypted chip ID and an encrypted content ID, the encrypted chip ID being obtained by encrypting, by a first key, a chip ID which is uniquely set and non-rewritably and originally recorded in the IC chip, and the encrypted content ID being obtained by encrypting, by the first key, a content ID generated by a specific process to uniquely identify content recorded on the content recording medium, reading out the chip ID, the encrypted chip ID, and the encrypted content ID in the IC chip;
decrypting the read encrypted chip ID and encrypted content ID by a second key which makes a pair with the first key;
detecting a match/mismatch between the decrypted and regenerated chip ID and content ID and the read chip ID and a content ID generated by a same process as the specific process; and
allowing playback of the content on the content playback apparatus only when results of the detections match.
